(19) United States
(12) Patent Application Publication
(10) Pub. No.: US 2010/0038878 A1
(43) Pub. Date: Feb. 18, 2010

(54) Universal wheel seat

(76) Inventor: Chiu-Te Chen, Miaoli County (TW)

Correspondence Address: BACON & THOMAS, PLLC, 625 SLATERS LANE, FOURTH FLOOR, ALEXANDRIA, VA, 22314-1176, US

(21) Appl. No.: 12/222,654

(22) Filed: Aug. 13, 2008

(51) Int. Cl. B60G 3/00

(52) U.S. Cl. 280/149.1

(57) ABSTRACT

A universal wheel seat includes a chassis and a rotor that is composed of an inner seat, an outer seat and several balls. A fixing bolt is inserted through the chassis and the inner seat to firmly combine the chassis and the rotor together. By so designing, different-sized chassis and rotor can be optionally paired and assembled together by the fixing bolt in accordance with a customer's need.

### BACKGROUND OF THE INVENTION

1. Field of the Invention

This invention relates to a universal wheel seat, particularly to one provided with a fixing bolt to be inserted through a chassis and an inner seat in a rotor positioned beneath the chassis for firmly combining the chassis and the inner seat together. Thus, different-sized chassis and rotor can be optionally paired and assembled together, able to lower stock cost and quick in assembling.

2. Description of the Prior Art

A conventional universal wheel seat 10, as shown in FIGS. 1, 2 and 3, includes a chassis 11, an outer seat 12 and two support arms 14 combined together.

The chassis 11 has its topside employed for securing one support leg of a handcart thereon, having the central portion of its underside forged and shaped into an inner seat 110 protruding downward and having its outer wall formed with a semi-circular holding recessed wall 111.

The outer seat 12 is formed with a hollow interior to be fitted around the inner seat 110 of the chassis 11, having its hollow inner wall formed with a semi-circular holding recessed wall 120 corresponding with the semi-circular holding recessed wall 111 of the inner seat 110. A circular holding recessed wall formed by combining together the two semi-circular holding recessed walls 111, 120 of the inner seat 110 and the outer seat 12 is received therein with a plurality of balls 13, which combine the outer seat 12 and the inner seat 110 together to form a rotor for enabling the outer seat 12 to rotate freely around the inner seat 110.

The two support arms 14 have their upper ends respectively and firmly welded with the underside of the outer seat 12 and their lower ends pivotally assembled with a wheel 15.

As mentioned above, the chassis 11 and the inner seat 110 of the conventional universal wheel seat 10 are integrally forged in shape so the conventional universal wheel seat 10 has the following drawbacks in manufacturing.

1. Being shaped integrally with the inner seat 110, the chassis 11 and the rotor are fixed and limited in specifications, that is, a large-sized chassis 11 cannot be paired and assembled with a small-sized rotor and vice versa. Therefore, it is necessary to prepare various molds with different specifications for producing different-sized chassis 11 and rotors to be freely paired and assembled together according to a customer's need, thus increasing producing cost.

2. Being forged integrally, the chassis 11 and the inner seat 110 cannot be shaped quickly.

To improve the defects mentioned above, the chassis 11 and the inner seat 110 can be shaped separately and then the inner seat 110 is welded and combined with the underside of the chassis 11. But, it will take much time to have the circumferential edge of the inner seat 110 welded and secured with the chassis 11, and combination by welding is likely to cause deformation to parts.

### SUMMARY OF THE INVENTION

This invention has been devised to offer a universal wheel seat able to have different-sized chasses and rotors freely paired and assembled together for meeting a customer's need, quick in shaping and assembling and able to lower producing cost.

The feature of this invention is a fixing bolt employed to be inserted through the chassis and the inner seat in the rotor to firmly combine them together. Thus, a customer can pick out different-sized chasses and rotors he needs and then fixedly combine them together by the fixing bolt.

### BRIEF DESCRIPTION OF DRAWINGS

This invention will be better understood by referring to the accompanying drawings, wherein:

FIG. 1 is a perspective view of a conventional universal wheel seat;

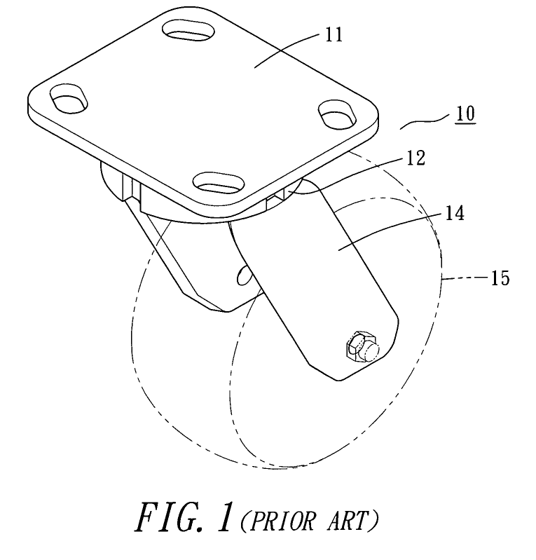

FIG. 2 is an exploded perspective view of the conventional universal wheel seat;

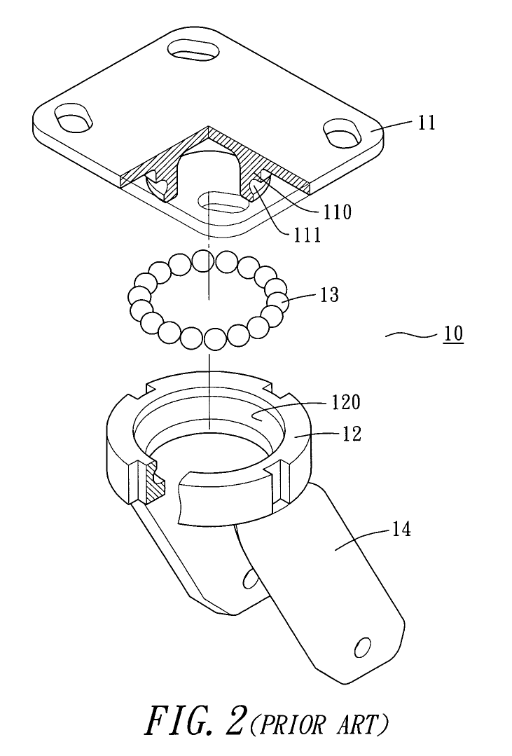

FIG. 3 is a cross-sectional view of the conventional universal wheel seat;

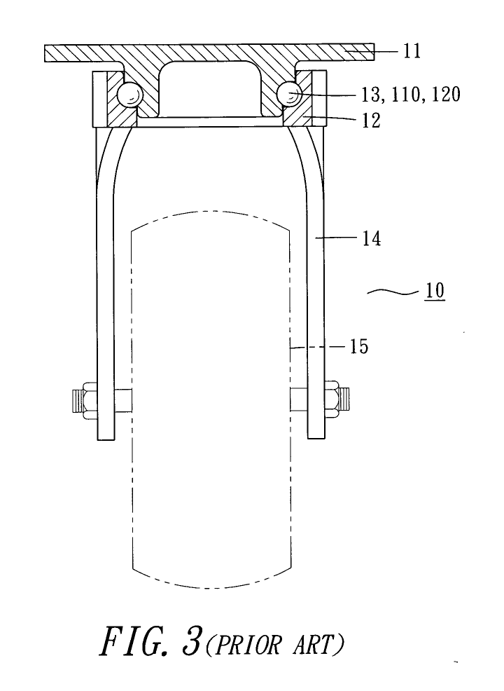

FIG. 4 is a perspective view of a universal wheel seat in the present invention;

FIG. 5 is an exploded perspective view of the universal wheel seat in the present invention;

FIG. 6 is a cross-sectional view of the universal wheel seat in the present invention;

FIG. 7 is an exploded perspective view of the universal wheel seat in the present invention, showing that a chassis and a rotor of different specifications are to be optionally assembled together;

FIG. 8 is another exploded perspective view of the universal wheel seat in the present invention, showing that different-sized chassis and rotor are to be paired and combined together; and

FIG. 9 is an exploded perspective view of the universal wheel seat in the present invention, showing that a screw and a nut take the place of a fixing rivet.

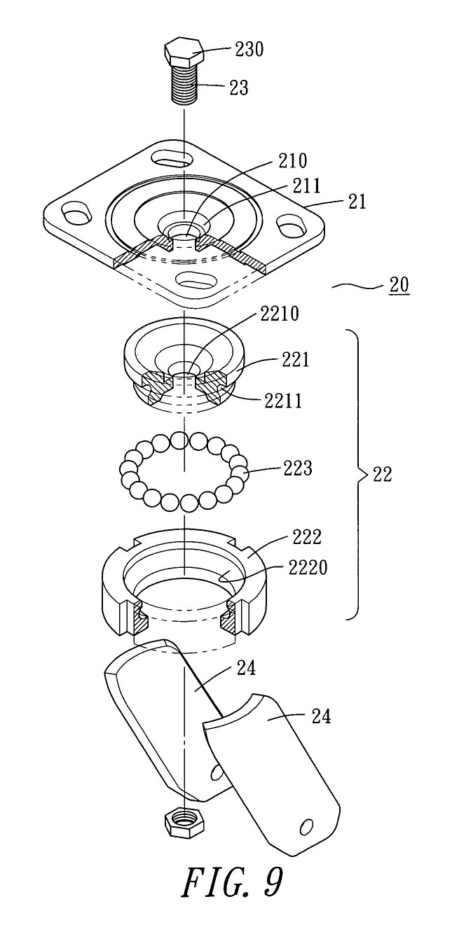

### DETAILED DESCRIPTION OF THE PREFERRED EMBODIMENT

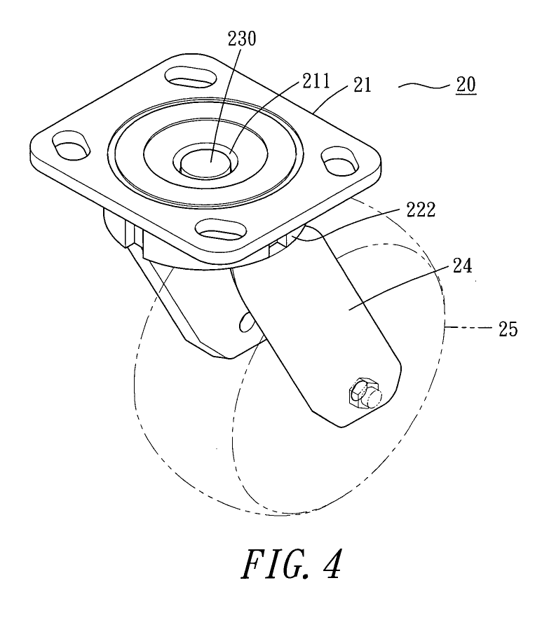

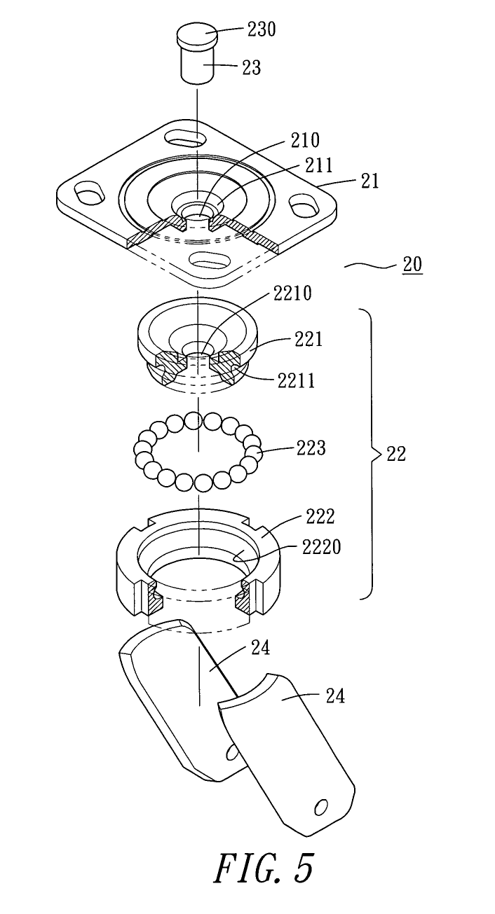

A preferred embodiment of a universal wheel seat 20 in the present invention, as shown in FIGS. 4 and 5, includes a chassis 21, a rotor 22, a fixing bolt 23 and two support arms 24 as main components combined together.

The chassis 21 has its top end used for combining the lower end of a leg of a handcart and its center bored with an insert hole 210 having its annular edge dented and formed with a holding recessed groove 211.

The rotor 22 to be assembled beneath the chassis 21 is composed of an inner seat 221, an outer seat 222 fitted around the outer circumference of the inner seat 221, and plural balls 223 positioned between the inner seat 221 and the outer seat 222. The inner seat 221 has its center bored with a shaft hole 2210 matching with the insert hole 210 of the chassis 21 and its lower outer wall dented and formed with an annular holding recessed wall 2211. The outer seat 222 is formed with a hollow interior having its inner wall dented and formed with an annular holding recessed wall 2220 matching with the holding recessed wall 2211 of the inner seat 221. An annular circular groove formed by combining together the two holding recessed walls 2211 and 2220 receive plural balls 223 therein for combining the inner seat 221 and the outer seat 222 together.

The fixing bolt 23 with a head 230, which can be a rivet, is inserted from the upper side of the chassis 21 to pass through the insert hole 210 of the chassis 21 and the shaft hole 2210 of the inner seat 221 of the rotor 22 to combine the chassis 21 and the inner seat 221 firmly together, such as combined by riveting.

The two support arms 24 are respectively secured at the opposite lower ends of the outer seat 222 of the rotor 22 for pivotally assembling a wheel 25.

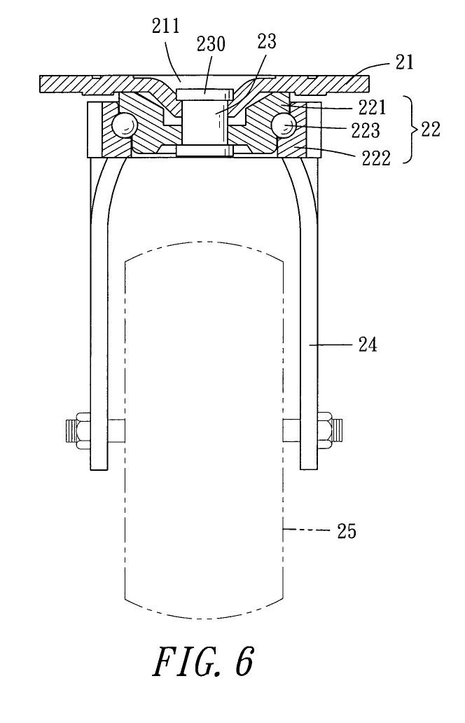

After foresaid members are orderly assembled, as shown in FIGS. 4 and 6, the fixing bolt 23 has its top head 230 inserted in the holding recessed groove 211 of the chassis 22 to firmly combine the chassis 22 and the inner seat 221 together. Thus, the support arms 24 together with the outer seat 222 and the wheel 25 can be actuated to rotate freely around the inner seat 221 by means of the balls 223.

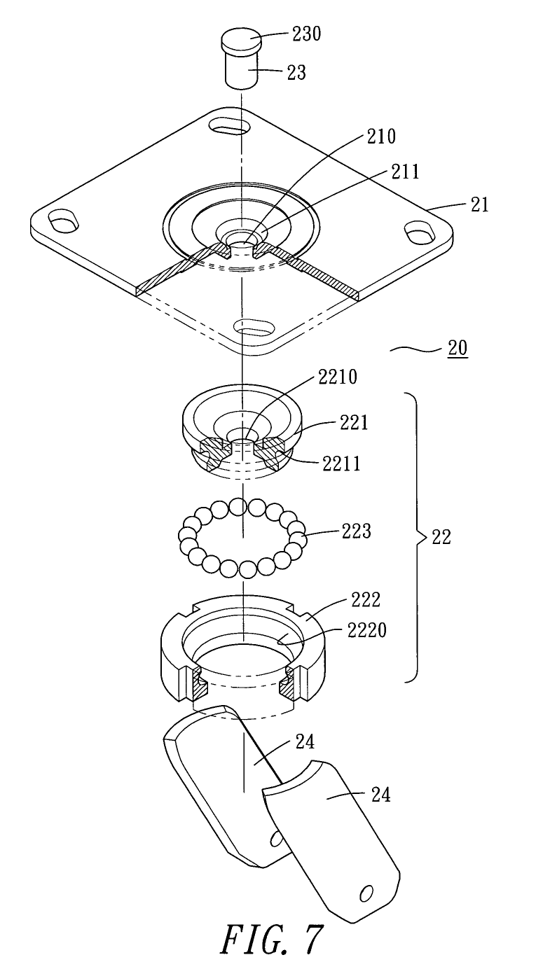

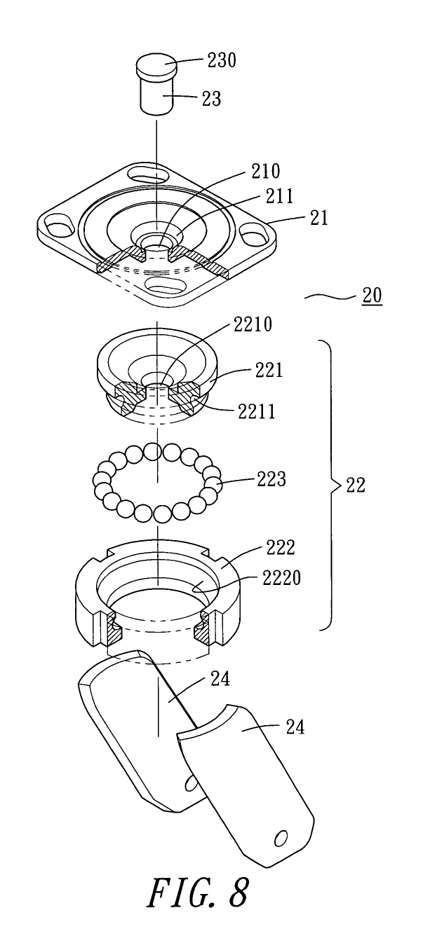

The chassis 21 and the inner seat 221 of the rotor 22 are fixedly combined together by the fixing bolt 23; therefore, the chassis 21 and the rotor 22 can be manufactured with various specifications in accordance with customers' need, and different-sized chassis 21 and rotor 22 can be optionally paired and assembled together, as shown in FIGS. 7 and 8, able to meet customers' various requirements, with stock amount and producing cost possible to be reduced substantially. Further, the chassis 21 and the inner seat 221 of the rotor 22 can quickly be combined together by the fixing bolt 23. In addition, the fixing bolt 23 can be substituted by a screw and a nut.

To sum up, the universal wheel seat of this invention is original, practical and progressive.

While the preferred embodiment of the invention has been described above, it will be recognized and understood that various modifications may be made therein and the appended claims are intended to cover all such modifications that may fall within the spirit and scope of the invention.

I claim:

1. A universal wheel seat comprising:
a chassis having its top side used for combining lower end of a leg of a handcart, said chassis bored with an insert hole in the center;
a rotor assembled beneath said chassis, said rotor composed of an inner seat, an outer seat fitted on an outer circumference of said inner seat and plural balls positioned between said inner seat and said outer seat, said inner seat bored in the center with a shaft hole matching with said insert hole of said chassis, said inner seat having its lower outer wall dented and formed with an annular holding recessed wall, said outer seat formed with a hollow interior having its inner wall dented and formed with an annular holding recessed wall corresponding with said holding recessed wall of said inner seat, an annular circular groove formed by combining together both said holding recessed walls, said annular circular groove receiving plural balls therein, said balls combining said inner seat and said outer seat together;
a fixing bolt inserted from topside of said chassis to pass through said insert hole of said chassis and said shaft hole of said inner seat of said rotor, said fixing bolt firmly combining said chassis and said inner seat together; and
two support arms respectively secured with a lower end of said outer seat of said rotor, said two support arms pivotally assembled with a wheel.

2. The universal wheel seat as claimed in claim 1, wherein said insert hole in an upper side of said chassis has its edge dented downward and formed with a holding recessed groove for a head of said fixing bolt to be inserted therein.

3. The universal wheel sear as claimed in claim 1, wherein said fixing bolt is a rivet.

4. The universal wheel seat as claimed in claim 1, wherein said fixing bolt is a screw of a nut combined together.
